(19) United States
(12) Patent Application Publication
(10) Pub. No.: US 2026/0236748 A1
(43) Pub. Date: Aug. 13, 2026

(54) RESIDUAL CONVOLUTIONAL NEURAL NETWORK FOR LOW-COMPUTATIONAL POWER APPLICATIONS

(71) Applicant: UNIVERSITY OF MIAMI, Miami, FL (US)

(72) Inventors: Görkem Can ATES, Miami, FL (US); Emrah CELIK, Miami, FL (US); David Tsang TSE, Miami, FL (US)

(21) Appl. No.: 19/156,694

(22) PCT Filed: Feb. 14, 2024
(86) PCT No.: PCT/US2024/015839

§ 371 Date: Aug. 14, 2025

Related U.S. Application Data
(60) Provisional application No. 63/484,836, filed on Feb. 14, 2023.

(51) Int. Cl. G06N 3/0464; G06N 3/048

(52) U.S. Cl. CPC G06N 3/0464; G06N 3/048

(57) ABSTRACT

A residual convolutional neural network (Res-CNN) generates accurate and real-time predictions for low computational power applications. The Res-CNN advantageously includes operations such as residual connections, Squeeze and Excitation (SE) attention, and Atrous Spatial Pyramid Pooling (ASPP) to improve the prediction performance without complicating the model. Moreover, transfer learning is leveraged by training synthetic sensor inputs (e.g., synthetic images), and then fine-tuning the model with authentic sensor input (e.g., authentic images). In some implementations, the model parameters of the Res-CNN are also fully quantized to speed up the predictions and apply the Quantization Aware Training (QAT) strategy to obtain accurate predictions. The Res-CNN can be implemented on an embedded controller to receive and process inputs from one or more sensors and responsively actuate one or more actuators of associated equipment.

### RELATED APPLICATION

This PCT application claims priority to, and the benefit of, U.S. Provisional Patent Application No. 63/484,836, filed Feb. 14, 2023, which is incorporated by reference herein in its entirety.

### BACKGROUND

Existing Deep Fully Convolutional Network (DFCN) segmentation models have been shown to perform robust and accurate predictions. Although DFCN-based segmentation frameworks can provide accurate and robust operation, they demand high computational resources. As a result, DFCNs suffer from slow response time in providing real-time predictions and/or in low computational applications, such as wearable devices, embedded controllers, and single-board computers, such as a Raspberry Pi. Simple FCN models, on the other hand, can provide real-time yet not as accurate predictions with low computational devices.

Traditional control systems include programmable logic controllers that require direct programming of control logic or proportional integral derivative (PID) controllers that chase set point values and often overshoot or undershoot set point values as part of the control operation and require tuning of the control values.

### SUMMARY

According to a first aspect of the disclosure, a system comprises equipment with one or more actuators and an embedded controller. The embedded controller is in communication with one or more sensors and configured to process inputs from the sensors and responsively actuate the actuators.

In various implementations of the first aspect of the disclosure, the embedded controller comprises a Residual Convolutional Neural Network (Res-CNN). The Res-CNN comprises a series of a plurality of residual blocks. Each of the residual blocks comprises a first connection sequence including a convolutional layer, a fully connected layer, and a batch normalization layer between the convolutional layer and the fully connected layer. Each of the residual blocks further comprises a skip connection, including a second convolutional layer and a second batch normalization layer. Outputs of the first connection sequence and the skip connection are summed.

The Res-CNN also comprises a squeeze and excitation network between each of the plurality of residual blocks. The Res-CNN also comprises an Atrous Spatial Pyramid Pooling (ASPP) block at an output of the series of the plurality of residual blocks. The Res-CNN also comprises a global average pooling (GAP) block at an output of the ASPP block. The Res-CNN also comprises a linear block at an output of the GAP block. Finally, the Res-CNN comprises an output block at an output of the linear block.

In various implementations of the first aspect of the disclosure, each of the first connection sequences of each of the residual blocks further comprises a third convolutional layer after the batch normalization layer and a third batch normalization layer after the third convolutional layer.

In various implementations of the first aspect of the disclosure, each of the residual blocks further comprises a second fully connected layer at an output of the sum.

In various implementations of the first aspect of the disclosure, the squeeze and excitation network comprises a second GAP block configured to collect global spatial information of an input feature map to the squeeze and excitation network. The squeeze and excitation network further comprises a third fully connected network and a fourth fully connected network configured in a second sequence with the second GAP block to produce output attention vectors. The attention vectors are multiplied by the input feature map.

In various implementations of the first aspect of the disclosure, the ASPP block comprises a plurality of convolution blocks, each with a different dilation rate. Each of the plurality of convolution blocks comprises a third sequence with a fourth convolutional layer, a fifth fully connected layer, and a fourth batch normalization layer between the fourth convolutional layer and the fifth fully connected layer. The ASPP block further comprises a concatenation layer configured to concatenate feature maps from the plurality of convolution blocks along a channel dimension. The ASPP block further comprises a convolutional block configured to produce a final feature map as the output for the ASPP block.

In various implementations of the first aspect of the disclosure, the linear block comprises a fourth sequence with a linear layer, a sixth fully connected layer, and a fifth batch normalization layer.

In various implementations of the first aspect of the disclosure, the series of a plurality of residual blocks includes three residual blocks.

In various implementations of the first aspect of the disclosure, the output block includes a linear layer with a number of neurons equal to a number of output classes to the Res-CNN and an activation layer.

In various implementations of the first aspect of the disclosure, the activation layer is a fully connected layer with an activation function selected from the group of activation functions consisting of: a sigmoid function, a softmax function, a Tanh function, a step function, a softplus function, a ReLu function, and a softsign function.

In various implementations of the first aspect of the disclosure, the one or more sensors include one or more of a camera, an image sensor, an optical sensor, a temperature sensor, a pressure sensor, a proximity sensor, a position sensor, a displacement sensor, a force sensor, an accelerometer, a voltage sensor, a current sensor, a gas sensor, a smoke sensor, a decibel meter, or a microphone.

In various implementations of the first aspect of the disclosure, the one or more actuators include one or more of a linear actuator, a rotary actuator, a valve actuator, a slide gate actuator, a hydraulic actuator, an electric actuator, a pneumatic actuator, a magnetic actuator, trigger, button.

According to a second aspect of the disclosure, a non-transitory computer-readable medium comprises one or more memory structures of a Residual Convolutional Neural Network (Res-CNN). The Res-CNN comprises a series of a plurality of residual blocks. Each of the residual blocks comprises a first connection sequence including a convolutional layer, a fully connected layer, and a batch normalization layer between the convolutional layer and the fully connected layer. Each of the residual blocks further comprises a skip connection, including a second convolutional layer and a second batch normalization layer. The first connection sequence and the skip connection are summed in each of the residual blocks. The Res-CNN further comprises a squeeze and excitation network between each of the plurality of residual blocks. The Res-CNN further comprises an Atrous Spatial Pyramid Pooling (ASPP) block at an output of the series of the plurality of residual blocks. The Res-CNN further comprises a global average pooling (GAP) block at an output of the ASPP block. The Res-CNN further comprises a linear block at an output of the GAP block. The Res-CNN further comprises an output block at an output of the linear block.

In various implementations of the second aspect of the disclosure, each of the plurality of residual blocks in the series has an increased number of neurons than an immediately preceding residual block in the series.

In various implementations of the second aspect of the disclosure, each of the first connection sequences of each of the residual blocks further comprises a third convolutional layer after the batch normalization layer and a third batch normalization layer after the third convolutional layer.

In various implementations of the second aspect of the disclosure, each of the residual blocks further comprises a second fully connected layer at an output of the sum.

In various implementations of the second aspect of the disclosure, the squeeze and excitation network comprises a second GAP block configured to collect global spatial information of an input feature map to the squeeze and excitation network. The squeeze and excitation network also comprises a third fully connected network and a fourth fully connected network configured in a second sequence with the second GAP block to produce output attention vectors. The attention vectors are multiplied by the input feature map.

In various implementations of the second aspect of the disclosure, the ASPP block comprises a plurality of convolution blocks, each with a different dilation rate. Each of the plurality of convolution blocks comprises a third sequence with a fourth convolutional layer, a fifth fully connected layer, and a fourth batch normalization layer between the fourth convolutional layer and the fifth fully connected layer. The ASPP block further comprises a concatenation layer configured to concatenate feature maps from the plurality of convolution blocks along a channel dimension. The ASPP block further comprises a convolutional block configured to produce a final feature map as the output for the ASPP block.

In various implementations of the second aspect of the disclosure, the linear block comprises a fourth sequence with a linear layer, a sixth fully connected layer, and a fifth batch normalization layer.

In various implementations of the second aspect of the disclosure, the series of a plurality of residual blocks includes three residual blocks.

In various implementations of the second aspect of the disclosure, the convolutional layer in the first connection sequence has a 7×7 kernel size, and the second convolutional layer in the skip connection has a 3×3 kernel size.

In various implementations of the second aspect of the disclosure, the output block includes a linear layer with a number of neurons equal to a number of output classes to the Res-CNN and an activation layer.

In various implementations of the second aspect of the disclosure, the activation layer is a fully connected layer with an activation function selected from the group of activation functions consisting of: a sigmoid function, a softmax function, a Tanh function, a step function, a softplus function, a ReLu function, and a softsign function.

### BRIEF DESCRIPTION OF THE DRAWINGS

The accompanying drawings, which are incorporated in and constitute a part of this specification, illustrate embodiments and, together with the description, serve to explain the principles of the methods and systems. The patent or application file contains at least one drawing executed in color.

FIG. 1 shows a control system comprising an embedded controller configured to receive sensor data and responsively control an actuator in accordance with an illustrative embodiment.

FIG. 2 shows a system diagram of the embedded controller of FIG. 1 in accordance with an illustrative embodiment.

FIG. 3 shows a method of operation of the embedded controller of FIG. 1 in accordance with an illustrative embodiment.

FIGS. 4A, 4B, 4C, 4D, and 4E show various aspects of a Res-CNN that may be executed in a real-time loop to control an actuator based on sensor input in accordance with an illustrative embodiment.

FIGS. 5A, 5B, 5C, 5D, and 5E show experimental results of a prototyped control system in accordance with an illustrative embodiment.

### DETAILED DESCRIPTION

Each and every feature described herein, and each and every combination of two or more of such features, is included within the scope of the present invention, provided that the features included in such a combination are not mutually inconsistent.

Disclosed herein is a residual convolutional neural network (Res-CNN) that performs at a level of traditional DFCN with the real-time operation of simple FCN. The Res-CNN advantageously includes operations such as residual connections, Squeeze and Excitation (SE) attention, and Atrous Spatial Pyramid Pooling (ASPP) to improve the prediction performance without complicating the model. Moreover, transfer learning is leveraged by training synthetic sensor inputs (e.g., synthetic images) and then fine-tuning the model with authentic sensor input (e.g., authentic images). In some implementations, the model parameters of the Res-CNN is also fully quantized to speed up the predictions and apply the Quantization Aware Training (QAT) strategy to obtain accurate predictions. Experiments show that the quantized Res-CNN model trained by the QAT strategy with 40×30 resolution images provides robust yet real-time predictions with an average of 1.351 Root Mean Square Error (RMSE) for control operation predictions and 8.317 ms response time on a Raspberry Pi. This can be compared with response times of 400 ms for a traditional DFCN operating on a Raspberry Pi or 65 ms on a PC. In an example, the Res-CNN of this disclosure may include 3,368 parameters as opposed to 14,251 parameters of a DFCN.

Many control systems operate on computers with limited computing power, such as wearable devices, embedded controllers, and single-board computers (SBC), such as a Raspberry Pi. SBCs usually include a central processing unit (CPU) that is an ARM architecture-based processor and lacks a graphical processing unit (GPU). SBCs lack the GPUs mainly used in deep learning-based computer vision applications, and the CPU is nearly six times slower than that of a modem computer.

When using CNNs to perform predictions, the decoder part is replaced with fully connected layers that utilize features extracted by the encoder to give the final predictions. Such a strategy reduces the number of model parameters and mathematical operations, decreasing the prediction response time. Another method of increasing the prediction speed is adapting a quantization strategy that compresses models by reducing bits per weight [22]. Conventional post-quantization strategies such as scalar quantization, which reduces the precision of floating-point learned model parameters to integers, can significantly compress the models, thus reducing complexity [23]. Although these post-quantization strategies can reduce the complexity, lowering the precision for the model parameters can increase the numerical errors, ultimately leading to a decrease in accuracy [24]. One way to address this issue is by quantizing the model parameters throughout the training [22]. Quantization Aware Training (QAT) [25] framework can solve the above problems by quantizing all the model parameters in the forward propagation phase while computing gradients using a straight-through estimator (STE) [26, 27]. Therefore, this QAT strategy enables the development of robust, accurate, and fast models, particularly for real-time applications.

The Res-CNN disclosed herein can generate accurate and real-time predictions for low computational power applications. The QAT strategy is leveraged to achieve real-time prediction responses without sacrificing accuracy. Moreover, to increase the prediction performance without increasing the model complexity, the Res-CNN includes residual connections [10] to avoid the vanishing gradient problem and Squeeze and Excitation networks [28] as a robust mechanism to increase the attention to more valuable features. An Atrous Spatial Pyramid Pooling (ASPP) [29] layer is also integrated into the transition between convolutional and fully connected layers to capture the long-range dependencies in feature maps while significantly increasing the prediction speed. In some implementations, the Res-CNN also uses transfer learning using synthetic sensor inputs (e.g., eye image dataset, SynthesEyes Dataset [30]) to improve prediction performance further. Our experiments show that the Res-CNN with transfer learning and QAT strategies provides superior performance on prediction time and competitive results in detecting performance compared to state-of-the-art deep learning-based algorithms. Therefore, the proposed Res-CNN offers an alternative prediction or classification platform for applications that require additional restrictions such as portability and low computational power.

### Example System

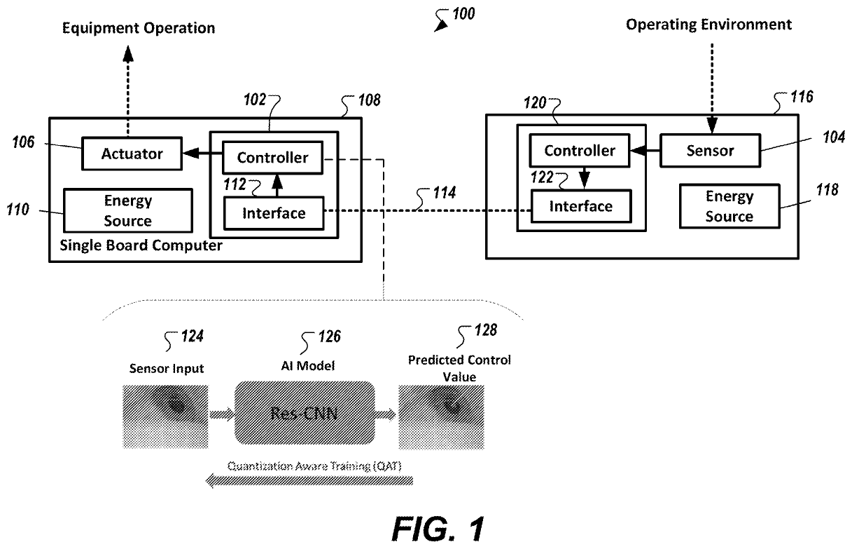

FIG. 1 shows s control system 100 comprising an embedded controller 102 configured to receive sensor data from a sensor 104 and responsively control an actuator 106, in accordance with an illustrative embodiment. In the example shown, the embedded controller 102 is part of a single-board computer (SBC) 108, such as a Raspberry Pi. Other system architectures using the embedded controller 102 are contemplated by this disclosure. For example, the embedded controller may be included on a piece of equipment such as a pump, valve, motion control device, or any other controlled equipment used in a commercial or industrial application. SBC 108 may variously be referred to as equipment 108 throughout this disclosure. The SBC 108 includes an energy source 110, such as a battery or a wired or wireless power coupling for supplying power to components of the SBC 108. The SBC 108 also includes an actuator 106 configured to perform an equipment operation, such as to open or close a valve, control the operation or flow rate of a pump, control direction, orientation, or extension of a motion control device, or perform any other such operation.

In various implementations, the actuator 106 may include one or more of a linear actuator, a rotary actuator, a valve actuator, a slide gate actuator, a hydraulic actuator, an electric actuator, a pneumatic actuator, a magnetic actuator, a trigger, a button, or any other device that performs an equipment operation responsive to a control signal.

While a single actuator 106 is shown in the example of FIG. 1, it is contemplated that the embedded controller 102 controls the operation of two or more actuators 106. While the actuator 106 is shown as part of the SBC 108, in some implementations, the actuator 106 is provided apart from or external to the SBC 108. In some implementations, two or more actuators 106 may be provided as part of the SBC 108 and/or external to the SBC 108 and controlled by the embedded controller 102. Other variations of arrangements for the embedded controller 102 to control the operation of one or more actuator 106 as part of or external to a system, including the embedded controller 102 are contemplated by this disclosure.

The embedded controller 102 controls the actuator 106 responsive to sensor signals received via an interface 112. The interface 112 includes one or more ports, modems, antennas, or other communication equipment configured to communicate sensor signals from the sensor 104 over a communication channel 114. The communication channel 114 may be a wired or wireless communication channel. In various implementations, the communication channel 114 may include one or more intermediary networks or switches for communication of sensor signals from a remote location to the embedded controller 102.

The sensor 104 senses the conditions of a surrounding operating environment. In various implementations, the sensor 104 includes one or more of a camera, an image sensor, an optical sensor, a temperature sensor, a pressure sensor, a proximity sensor, a position sensor, a displacement sensor, a force sensor, an accelerometer, a voltage sensor, a current sensor, a gas sensor, a smoke sensor, a decibel meter, or a microphone.

The sensor 104 may be a standalone device or incorporated into a sensor system 116. The sensor system 116 may include an energy source 118, such as a battery or wired or wireless power coupling, for powering the sensor 104 and other components of the sensor system 116.

The sensor system 116 may additionally include a controller 120 configured to process raw sensor data generated by the sensor 104. For example, the sensor 104 may simply produce a current, voltage, capacitance, inductance, resistance, or other detected value as raw sensor data. The controller 120 may then convert the raw sensor data into measured sensor data such as a temperature, pressure, weight, distance, presence, torque, or other measured values. For image sensors, the controller 120 may perform image processing functions, such as color correction, cropping, scaling, or other such image processing to put a captured image in a better form for the embedded controller 102 to process such images. In some implementations, the embedded controller 102 simply receives the raw sensor data generated by the sensor 104 and performs any desired conversions or processing locally. In some implementations, the sensor 104 itself includes logic for the conversion of raw sensor data to measured sensor data.

The sensor system 116 includes an interface 122 for communicating the sensor signals (e.g., raw, measured, or otherwise processed sensor data) to the embedded controller 102 via the communication channel 114. Similar to the above, the interface 122 includes one or more ports, modems, antennas, or other communication equipment configured to communicate sensor signals from the sensor 104 over the communication channel 114.

While the sensor 104 is shown as part of the sensor system 116 in the example of FIG. 1, in some implementations, the sensor 104 simply directly communicates sensor signals to the embedded computer via the communication channel 114. For example, a wire directly couples the embedded controller 102 with the sensor 104.

As described in more detail below, the embedded controller 102 processes sensor inputs 124 (e.g., raw sensor data, measured sensor data, processed sensor data) using a Res-CNN model 126 and produces one or more predicted control values 128. The embedded controller 102 may use the predicted control value(s) 128 to directly control the actuator 106 or may process the predicted control value(s) 128 to generate control signals for controlling the actuator 106. For example, the predicted control value(s) 128 may be drive voltage or other such predicted value that is directly used by the controller to control the actuator 106. In another example, the predicted control value(s) 128 may be positional data (e.g., target position) that the embedded controller 102 uses to calculate a drive distance for moving the actuator 106 from a current position to the target position.

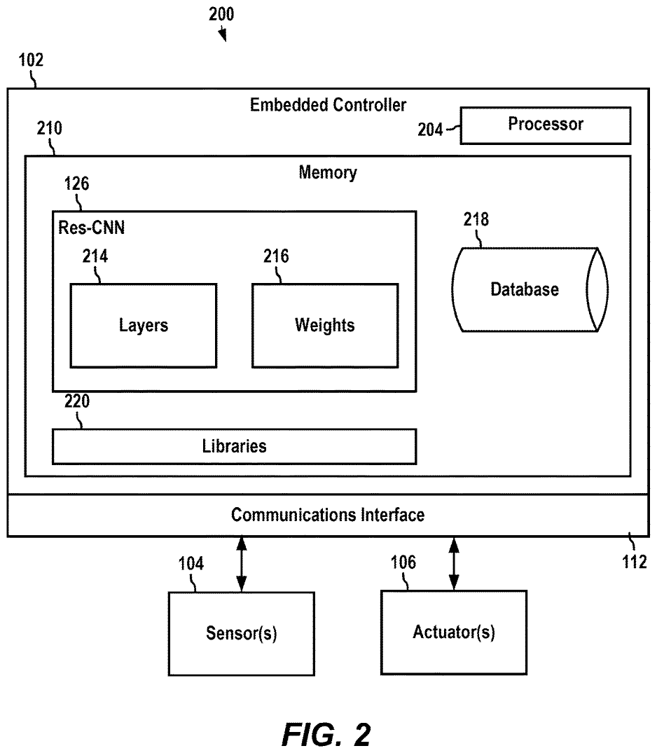

FIG. 2 shows a system diagram 200 of the embedded controller 102 of FIG. 1, in accordance with an illustrative embodiment. System 200 generally includes or is a computing device (e.g., a workstation, a server, a single-board computer, etc.) or a group of computing devices. System 200 is shown to include a processing circuit that includes a processor 204 and a memory 210. Processor 204 can be a general-purpose processor, an application-specific integrated circuit (ASIC), one or more field programmable gate arrays (FPGAs), a group of processing components, or other suitable electronic processing structures. In some embodiments, processor 204 is configured to execute program code stored on memory 210 to cause system 200 to perform one or more operations, such as execution of the Res-CNN 126, as described below in greater detail.

Memory 210 can include one or more devices (e.g., memory units, memory devices, storage devices, etc.) for storing data and/or computer code for completing and/or facilitating the various processes described in the present disclosure. In some embodiments, memory 210 includes tangible (e.g., non-transitory), computer-readable media that store code or instructions executable by processor 204. Tangible, computer-readable media refers to any physical media that is capable of providing data that causes system 200 to operate in a particular fashion. Example tangible, computer-readable media may include, but is not limited to, volatile media, non-volatile media, removable media, and non-removable media implemented in any method or technology for storage of information such as computer-readable instructions, data structures, program modules, or other data. Accordingly, memory 210 can include random access memory (RAM), read-only memory (ROM), hard drive storage, temporary storage, non-volatile memory, flash memory, optical memory, or any other suitable memory for storing software objects and/or computer instructions. Memory 210 can include database components, object code components, script components, or any other type of information structure for supporting the various activities and information structures described in the present disclosure. Memory 210 can be communicably connected to processor 204 and can include computer code for executing (e.g., by processor 204) one or more processes described herein.

While shown as individual components, it will be appreciated that processor 204 and/or memory 210 can be implemented using a variety of different types and quantities of processors and memory. For example, processor 204 may represent a single processing device or multiple processing devices. Similarly, memory 210 may represent a single memory device or multiple memory devices. Additionally, in some embodiments, system 200 may be implemented within a single computing device (e.g., one single-board computer, one server, one housing, etc.). In other embodiments, system 200 may be distributed across multiple servers or computers (e.g., that can exist in distributed locations). For example, system 200 may include multiple distributed computing devices (e.g., multiple processors and/or memory devices) in communication with each other that collaborate to perform operations. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by two or more computers. For example, virtualization software may be employed by system 200 to provide the functionality of a number of servers that is not directly bound to the number of computers in system 200.

Memory 210 is shown to include the Res-CNN 126, a database 218, and libraries 220 of programming code for implementation of the Res-CNN 126. The Res-CNN 126 is a neural network with a memory structure comprising layers 214 of nodes connected via one or more layers. The nodes can have numeric weights 216 that can be tuned during training of the neural network based on experience, which makes the neural network adaptive and capable of learning. For example, the numeric weights 216 can be used to train the neural network such that the neural network can perform the one or more functions on a set of input variables and produce an output that is associated with the set of input variables. In various implementations, the memory structures of the neural network may be stored as tensors.

In some embodiments, the neural network outputs a confidence score for the prediction. A confidence score generally indicates a likelihood that the prediction is correct. For example, if a machine learning model produces a prediction with a 95% confidence score, then it is highly likely that the prediction is correct, whereas a confidence score of 40% would indicate that the prediction may not be accurate.

The training of the neural network can be formulated as solving a constrained optimization problem. The goal of the optimization problem is to identify a set of optimized weights for the neural network so that a loss function of the neural network is minimized under a constraint that defines the relationship between the input variables and a desired output. Machine learning models may be trained using any suitable supervised or unsupervised training method. In various implementations, the Res-CNN 126 is trained using QAT.

The libraries 220 may include PyTorch, TensorFlow, or any other library for deep learning using GPUs and CPUs. In some implementations, the libraries 220 may be omitted. In such instances, the Res-CNN may be a precompiled neural network.

Certain aspects of the disclosure include operations and data structures with respect to the Res-CNN that improve how low computational power embedded computing systems control actuators responsive to sensor inputs. Such a structure can improve the operations of the neural network by reducing the number of nodes and optionally leveraging quantization to reduce computational resources required to run the Res-CNN while at the same time maintaining the accuracy of predictions of more computationally robust neural networks. Additional or alternative aspects of the disclosure can implement or apply rules of a particular type that improve existing technological processes involving machine-learning techniques. For instance, in order to reduce the computational load of the Res-CNN without sacrificing predictive performance, a particular architecture of the Res-CNN is disclosed. The embedded controller 102 is a specialized computing system that may be used for low compute power real-time processing of sensor data while still maintaining state-of-the-art prediction performance.

Examples of architectural features of the neural network can include the number of layers 214, the number of nodes in each layer 214, the activation functions for each node, or some combination thereof. For example, a neural network may include an input layer, one or more hidden layers, and an output layer. In some implementations, no hidden layers may be present. For instance, the dimension of the input variables can be utilized to determine the number of nodes in the input layer. Likewise, the number of desired outputs can be used to determine the number of nodes in the output layer, that is, one node in the output layer corresponds to one output. Other aspects of the neural network, such as the number of hidden layers, the number of nodes in each hidden layer, and the activation function at each node can be determined based on various factors such as the complexity of the prediction problem, available computation resources, accuracy requirement, and so on.

The output of a node or an output layer node can be determined by an activation function implemented at that particular node. In some aspects, the output of each of the nodes can be modeled as a logistic function of the input to that node, and the output of the neural network can be modeled as a logistic function of the outputs of the nodes in the last hidden layer.

Further, in addition to the activation functions described herein, the neural network can have any activation function that accepts real number inputs and outputs a real number. Examples of activation functions include, but are not limited to, the logistic, arctangent, sigmoid, and hyperbolic tangent functions. In addition, different layers of the neural network can employ the same or different activation functions.

Still referring to FIG. 2, system 200 is also shown to include a communications interface 112. Communications interface 112 may facilitate communications between system 200 and any external components or devices, including sensors 104 and actuators 106. For example, communications interface 112 can provide means for transmitting data to, or receiving data from, sensors 104 and actuators 106. Accordingly, communications interface 112 can be or can include a wired or wireless communications interface (e.g., jacks, antennas, transmitters, receivers, transceivers, wire terminals, etc.) for conducting data communications or a combination of wired and wireless communication interfaces. In some embodiments, communications via communications interface 112 are direct (e.g., local wired or wireless communications) or via a network (e.g., a WAN, the Internet, a cellular network, etc.). For example, communications interface 112 may include one or more Ethernet ports for communicably coupling system 112 to a network (e.g., the Internet). In another example, communications interface 112 can include a WiFi transceiver for communicating via a wireless communications network. In yet another example, communications interface 112 may include cellular or mobile phone communications transceivers.

As described above, the embedded controller 102 receives sensor signals (e.g., raw sensor data or measured sensor data) via the communications interface 112. In some implementations, the embedded controller 102 processes the received sensor signals to put them into a better form or structure as an input to the input layer of the Res-CNN. The embedded controller 102 then uses the Res-CNN to process input sensor data to generate one or more predicted control values. The predicted control values may be used directly as control signals for one or more actuators 106. In some implementations, the embedded controller 102 uses the predicted control values to calculate control signals that are sent to the actuators 106. The control signals may be delivered by the embedded controller 102 to the actuators 106 on the SBC 108 (e.g., via one or more wire traces) or separate from the SBC 108, such as via the communications interface 112.

### Example Methods

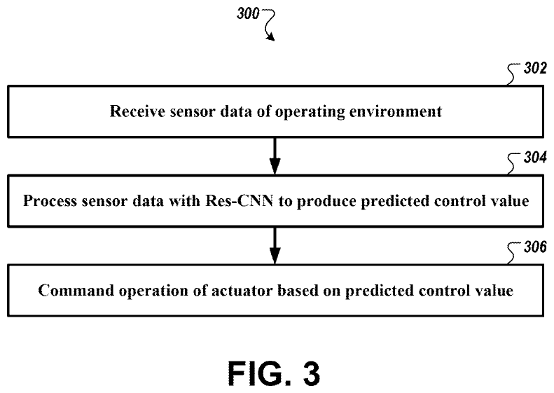

FIG. 3 shows a method 300 of operation of the embedded controller 102 of FIG. 1, in accordance with an illustrative embodiment. At 302, the embedded controller 102 receives sensor data of the operating environment from the sensors 104. The received sensor data may be raw sensor data, measured sensor data, and/or pre-processed sensor data.

At 304, the embedded controller 102 provides input sensor data to the Res-CNN 126 for processing and producing one or more predicted control values. The input sensor data may be the same as the received sensor data or produced from the received sensor data (e.g., processed to produce measured sensor data and/or pre-processed sensor data).

At 306, the embedded controller 102 commands the operation of one or more of the actuators 106. For example, the embedded controller 102 uses the predicted control values to directly command the operation of one or more actuators 106. Alternatively, the embedded controller 102 may process the predicted control values to produce one or more commands for the operation of one or more actuators 106. For example, the predicted control value may be a target position that is used to calculate one or more commands for moving the actuator 106 from a current position to the target position.

### Real-Time AI Model for Actuator System

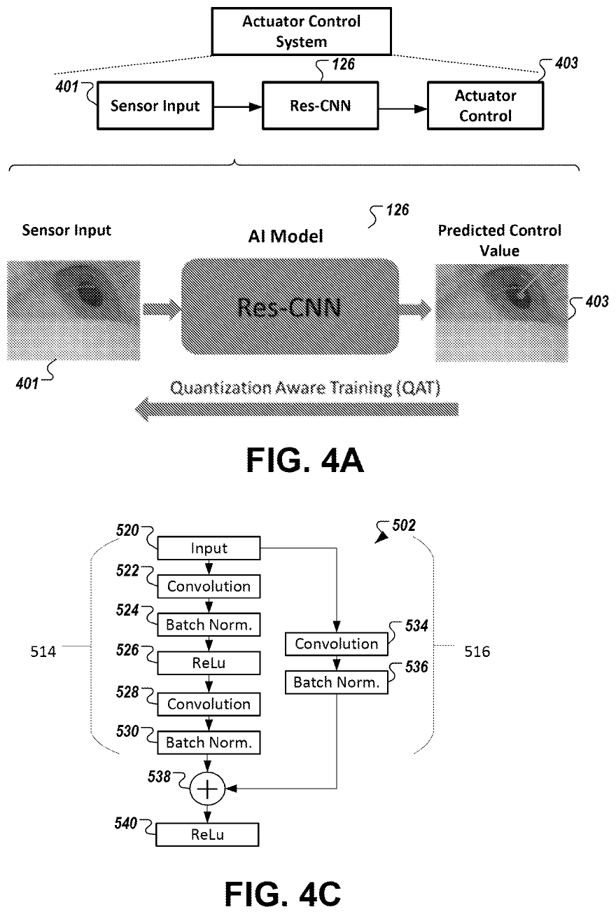

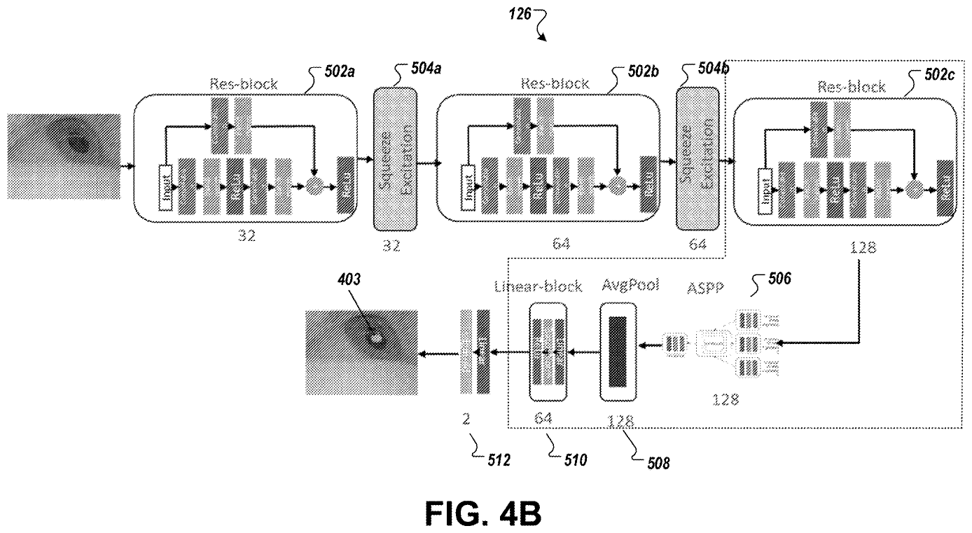

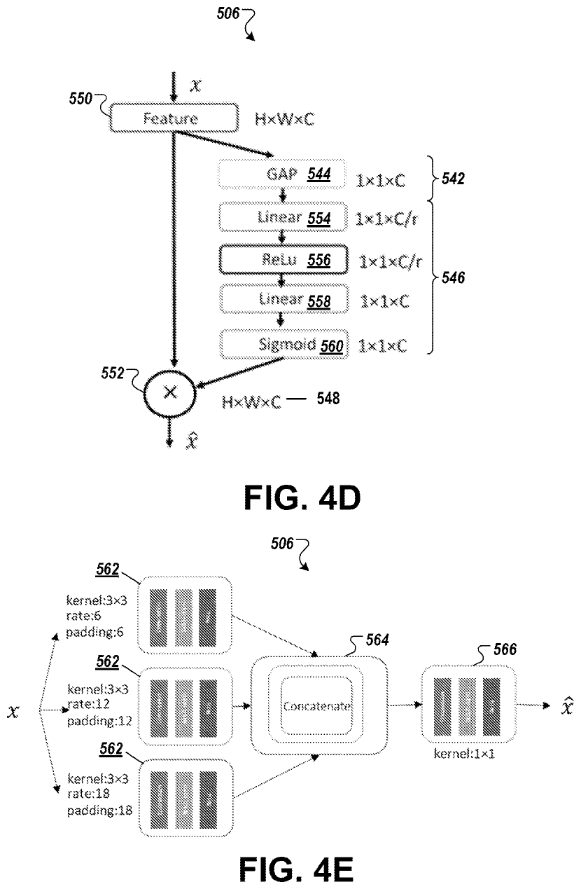

FIGS. 4A, 4B, 4C, 4D, and 4E show various aspects of a Res-CNN that may be executed in a real-time loop to control an actuator based on sensor input in accordance with an illustrative embodiment.

FIG. 4A shows an example Res-CNN model 126 configured to operate in real-time (e.g., greater to 30-millisecond control resolution) on a portable computing device (e.g., SBC 108) that can provide one or more control outputs used for controlling one or more actuators 106. In the example shown in FIG. 4A, sensor input 401 acquired by sensor 104 may be fed into the Res-CNN 126 with or without pre-processing. In various embodiments, raw sensor data from sensor 104 is input to the input layer of the Res-CNN. In the QAT training strategy, the Res-CNN 126 was trained by converting tensors from floating points to quantized points. Then, the lightweight, robust Res-CNN 126 with fully quantized layers is trained using QAT, and predicted control values are directly obtained. The output of the Res-CNN 126 is provided to actuator control 403, which provides the control signals to control the actuators 106.

The architecture of the Residual CNN 126 is shown in FIG. 4B. The Res-CNN 126 includes a series of a plurality, three in the example shown, of residual blocks 502a, 502b, and 502c, singularly or collectively residual blocks 502.

After each of the first residual block 502a and the second residual block 502b, a pioneer attention module is used, namely squeeze and excitation (SE) networks 504a and 504b, singularly or collectively SE networks 504. In other words, the SE networks 504 are positioned between each of the residual blocks 502. The SE networks 504 produce significant performance increases for the state-of-the-art CNN architectures with minimal additional computational cost [28].

At the end of the third residual block 502c, or otherwise at an output of the series of the plurality of residual blocks 502, an ASPP block 506 [11] is used to capture the long-range dependencies of feature maps before the fully connected layers. In an example implementation, the layers of the ASPP block 506 have 128 neurons. More or fewer neurons are contemplated.

Subsequently, at an output of the ASPP block 506, a Global Average Pooling (GAP) block 508 is used in the feature maps to achieve a fixed dimension for the fully connected layers. The GAP block 508 also helps the Res-CNN 126 model to collect the global information for each feature map and reduces the computational cost. In an example implementation, the layer of the GAP block 508 has 128 neurons. More or fewer neurons are contemplated.

Finally, a linear block 510 at an output of the GAP block 508 is used for regression. In the example shown, the linear block 510 includes a connection sequence of a linear layer, a batch normalization layer, and a fully connected layer (e.g., a ReLu layer). In an example implementation, the layers of the linear block 510 have 64 neurons. More or fewer neurons are contemplated.

An output block 512 is at an output of the linear block 510. Different output layers 512 can be selected depending on the problem to be solved with the Res-CNN. For example, for a two-dimensional regression problem with two output values, the output block 512 may include a single linear layer and an output sigmoid layer with two output nodes. In another example, for classification problems with multiple outputs (e.g., 2 or more), the output block 512 may include a linear layer sized according to the number of classes and an output softmax layer with two or more output nodes. Other types of output blocks with different activation functions are contemplated by this disclosure.

FIG. 4C is a detailed view of each of the residual blocks 502. The residual block 502 includes a first connection sequence 514 and a skip connection 516, where outputs of the first connection sequence 514 and the skip connection 516 are summed at a summation block 538. The result of the summation block 538 is provided to an output fully connected layer 540 (e.g., a ReLu layer).

The first connection sequence 514 includes an input layer 520 to a convolutional layer 522, a fully connected layer 526 (e.g., a ReLu layer with nonlinearity) with a batch normalization layer 524 between the convolutional layer 522 and the fully connected layer 526. In other words, the convolutional layer 522 is followed by the batch normalization layer 524 which is in turn followed by the fully connected layer 526. The first connection sequence 514 may additionally include a second convolutional layer 528 followed by a second batch normalization layer 530 with outputs coupled to or otherwise supply an input to the summation block 538.

In some implementations, the first connection sequence 514 uses a 7×7 kernel size for the convolutional layer 522 with Batch Normalization [31] and ReLu [32] nonlinearity provided by the batch normalization layer 524 and the fully connected layer 526, respectively. Note that such a sequence is recommended when using Batch Normalization with ReLu nonlinearity for CNNs [10, 21, 31]. As noted above, the convolutional block 528 follows the first conventional block 522 and, in some implementations, includes a 3×3 kernel size and a stride of 2 without any nonlinearity.

The skip connection 516 includes a third convolutional layer 534 followed by a third batch normalization layer 536. In some implementations, the third convolutional layer 534 includes a 3×3 kernel size and a stride of 2 without any nonlinearity. The skip connection 516 overcomes the vanishing gradient problem in deep CNNs and significantly increases performance in computer vision applications [10].

In some implementations, the first, the second, and the third residual blocks 502a, 502b, and 502c use 32, 64, and 128 filters for all convolutional layers, respectively. Except for the first convolutional layer within each of the residual blocks 502, which has a 7×7 kernel size, all the convolutional layers in each of the residual blocks 502 use a 3×3 kernel size.

FIG. 4D shows an example architecture of the SE network 504. In the SE Networks 504, the squeeze block 542 collects the global spatial information by applying a GAP layer 544. Then, the excitation block 546 captures channel-wise relationships and produces an output attention vector 548 using two fully connected layers with ReLu non-linearity. Finally, these attention vectors give weights to each input feature 550 by multiplying attention vector 548 with the original input feature maps [33] at a multiplication block 552. In the example shown, the excitation block 546 includes a linear layer 554, a fully connected layer with ReLu non-linearity 556, a second linear layer 558, and a second fully connected layer with sigmoid activation 560.

FIG. 4E shows an example architecture of the ASPP block 506. At the end of the third residual block 502c, the ASPP block 506 [11] is used to capture the long-range dependencies of the feature maps before the fully connected layers. The first part of the ASPP block 506 includes three convolutional blocks 562 (each following a sequence of a convolutional operation layer followed by a batch normalization layer and followed by a fully connected layer, such as a layer with ReLu nonlinearity) with 3×3 kernel size and 6, 12, and 18 dilation rates, respectively. Other kernel sizes and dilation rates are contemplated by this disclosure. Convolutional operations with different dilation rates capture the long-range dependencies among different pixels, thus providing a better feature extraction performance. Note that padding rates for each convolutional block 562 are used as 6, 12, and 18, respectively, to keep the original image resolution of input images.

The feature maps obtained from those three convolutional blocks with different dilation rates are then concatenated along the channel dimension in a concatenate block 564. A final convolutional block 566 (following a sequence of a convolutional operation layer followed by a batch normalization layer and followed by a fully connected layer, such as a layer with ReLu nonlinearity) with a 1×1 kernel size is performed to achieve the final feature maps.

### EXPERIMENTAL RESULTS AND EXAMPLES

A study was conducted to develop an AI model to detect/track pupil location and direct movement of the prosthesis in an orbital exenteration prosthesis system. The study is described in more detail in provisional application 63/484,867, filed Feb. 14, 2023, titled “Orbital Exenteration Prosthesis Synchronized Ocular Movement Integration System,” which is hereby incorporated by reference. The study included operations such as residual connections, SE, and ASPP to improve the prediction performance without significantly increasing the model parameters. The study also leveraged transfer learning by initially training the model with a dataset that only includes synthetic eye images and fine-tuning the same model with the actual eye dataset. Furthermore, the study integrated the QAT strategy to increase the speed of the predictions.

Experiments showed that the quantized Res-CNN model trained with QAT strategy using 40×30 resolution images performed well on the LPW test dataset while providing real-time predictions on Raspberry Pi with an average of 8.317 ms response time per image. It was also possible to consider 60×45 input images when real-time prediction performance is of interest. The quantized Res-CNN models with QAT outperformed conventional Res-CNN models with almost the same prediction accuracy.

Datasets. This study used the LPW [20] dataset to train a model. The characteristics of the LPW dataset include varying conditions such as gender, nationality, environment (indoor or outdoor), lighting type (natural or artificial), and makeup condition. The LPW dataset employed in the study included 66 high-resolution (640×480) videos obtained from 22 different participants. For each patient, three videos in different conditions are accepted, and each video consists of 2000 frames recorded at 95 FPS (nearly 130,856 frames). In the study, instead of all 130,856 frames, the study used 40 frames per video since (2640 in total) images obtained from high FPS will result in an increased number of similar images, which can affect the training performance.

The study used the transfer learning dataset, the SynthesEyes Dataset [30], which includes a collection of dynamic eye regions built with computer graphics. The dataset included 11,382 synthetic eye images with varying conditions, including skin color, skin smoothness, and eye shape. More details regarding the dataset can be found in [30].

Training Procedure. Before training, the study converted the input images for both SynthesEyes and LPW datasets to grayscale and resized from 640×480 to 40×30 using bilinear interpolation. Although resizing images before training causes information loss and may sacrifice prediction accuracy, the main aim of this study was to perform a robust CNN model that can perform real-time predictions. Therefore, images were resized to a fixed resolution of 40×30 to obtain real-time predictions. The dataset was randomly divided into training and validation groups with a ratio of 8:2. That is, 80% of the data was used for training, and the remaining 20% was used for validation. Adam [39] optimization method with a 10⁻⁵ initial learning rate in the training procedure was used to update the model parameters. Mean Square Error (MSE) was the loss function since the study aimed to find the pupil center coordinates directly. The formulation of MSE is provided in Equation 1.

$$MSE = \frac{1}{N} {\sum }_{\dot{I} = 1}^{N} {( {y}_{i} - {\hat{y}}_{i} )}^{2} \qquad ( 1 )$$

In Equation 1, N is the total training data points, yᵢ is the target value, and ŷᵢ is the model prediction. As for the performance metrics, Mean Absolute Error (MAE) and Root Mean Square Error (RMSE) were used. The formulations for MAE and RMSE metrics are provided in Eqs. (2) and (3), respectively.

$$MAE = \frac{1}{N} {\sum }_{\dot{I} = 1}^{N} \vert {y}_{i} - {\hat{y}}_{i} \vert \qquad ( 2 )$$

$$RMSE = \sqrt{\frac{1}{N} {\sum }_{\dot{I} = 1}^{N} {( {y}_{i} - {\hat{y}}_{i} )}^{2}} \qquad ( 3 )$$

For the LPW dataset, the instant Res-CNN model of the study was trained for 5,000 epochs, whereas for the SynthesEyes dataset, the model was trained for 600 epochs. The batch size for both datasets for training was selected as 32. Several different transforming methods, including random shifts and rotations (−60, 60 degrees), horizontal and vertical flips, gaussian and glass blurs, and Gaussian noise, were applied to the training input to improve the validation performance images. The images were only resized for the validation dataset and converted to grayscale.

Testing Procedure. The study used a single-board computer to test the Res-CNN model. The study imported the model to a Raspberry Pi 4B with a camera connected to its MIPI CSI port. Table 1 shows the specifications of the Raspberry Pi unit.

TABLE 1

| Hardware Specs | Raspberry Pi 4 Model B |
|---|---|
| CPU | ARM Cortex-A72, 1.5 GHz |
| CPU Cores | Quad-core |
| RAM | 4 GB LPDDR4 - 3200 MHz |
| Storage | 32 GB |
| Operating System | Raspbian 10 (Buster) |

The study ran the model on C++ by changing the processor affinity manually to utilize all 4 cores of the CPU. The study loaded the model into the program, and the video stream was started at 640×480 pixels and 35 FPS, enabling a new input frame every 28.57 ms. The input image was resized to 40×30 and was converted to grayscale to correspond to the format of the input layer of the model. The input tensor was normalized from 0-255 to 0-1, and a forward pass was performed on the model. The study calculated the time it took the Raspberry Pi to execute the forward pass and recorded the results for each frame. The study computed the average response time of 1000 frames.

### Results

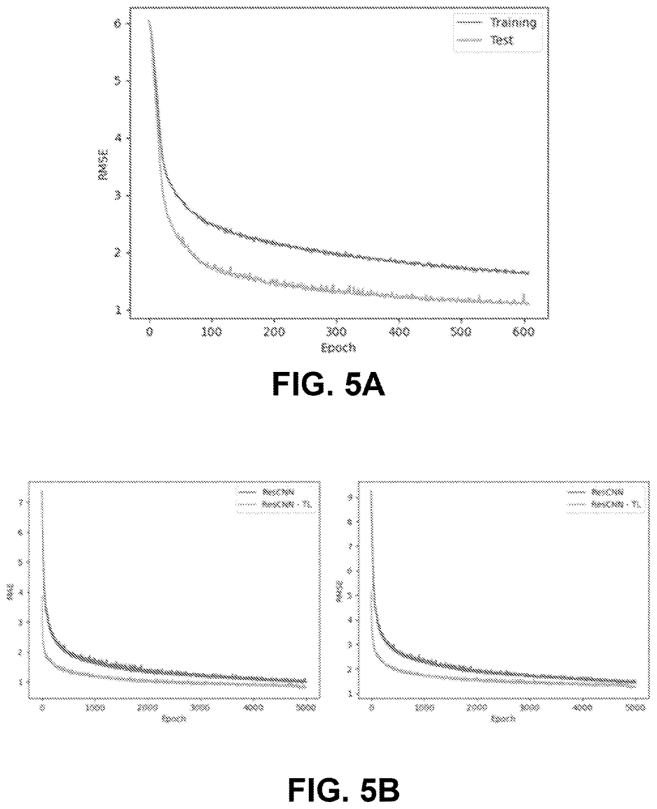

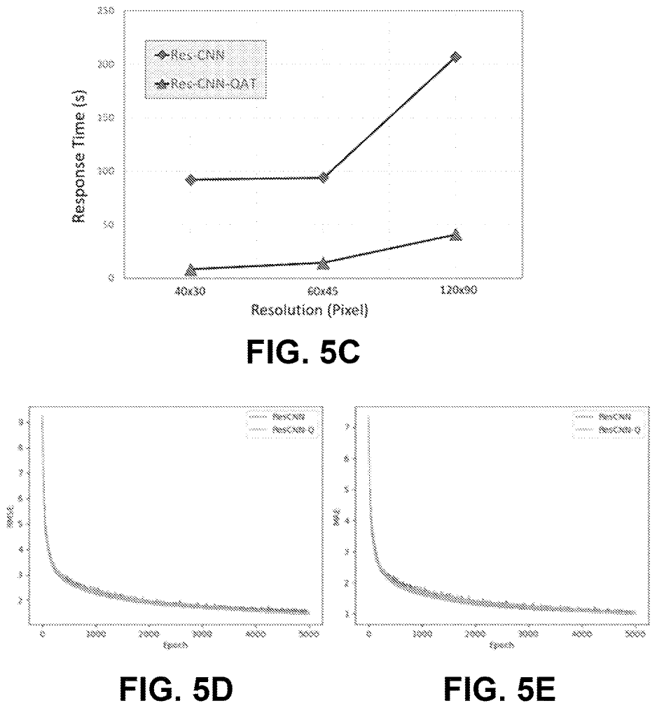

Model Performance Evaluation on the Datasets. FIG. 5A shows the RMSE curves during training for the initial quantized Res-CNN model. The training and test data learning curves show that the proposed model can learn the pupil center coordinates from the synthetic eye images. The best training and the test RMSE values were achieved as 1.654 and 1.091, respectively. These values correspond to coordinate error. Image resolution after resizing the training procedure was 40×30, which can also be considered coordinates.

According to the predictions, the initial Res-CNN model can accurately detect the pupil center with nearly a 1-pixel error on average.

The aim of pre-training the Res-CNN model on synthetic eye images was to enhance the prediction performance on authentic eye images by initializing a new model with its learned parameters. This may improve the prediction performance for real eye images since the initial Res-CNN model can provide prior information on extracting essential features by training with synthetic eye images.

The initial Res-CNN model can provide a generalizable performance for synthetic eye images. Thus, it is possible to transfer its trained parameters to initialize a new model with the same architecture, which can then be fine-tuned on authentic eye images.

FIG. 5B shows the effect of transfer learning on the LPW dataset. Specifically, FIG. 5B shows the MAE and RMSE comparison for the models trained with and without transfer learning. In FIG. 5B, the ResCNN corresponds to the model trained from scratch, whereas ResCNN-TL corresponds to the model with a transfer learning strategy. The weight initialization strategy recommended by [40] was used for the Res-CNN model that was trained from scratch.

It can be seen in FIG. 5B that the transfer learning framework improved the detection performance. For the model trained from scratch, the RMSE and MAE values for the pupil center predictions were achieved as 1.447 and 0.997, respectively. Whereas for the transfer learning model, the RMSE and MAE values were committed as 1.351 and 0.879, respectively.

The Res-CNN model with the QAT strategy can produce accurate pupil center predictions. In the literature, it is generally assumed that one can interpret the pupil center prediction as true positive only if the Euclidian distance between the prediction and the ground truth coordinates is less or equal to 5 pixels [17, 19, 20]. Since the mean RMSE value for the test dataset is 1.351, it was possible to conclude that the model developed in the study provided accurate and reliable predictions.

Prediction Speed of Res-CNN on Raspberry Pi. Since another purpose of implementing the QAT strategy was to obtain accurate predictions using small and portable devices at high speeds, the study conducted real-time tests using the quantized models on Raspberry Pi.

FIG. 5C shows the real-time prediction response times using quantized and non-quantized Res-CNN models at various input image resolutions. To obtain consistent response time measurements, the mean, standard deviation, maximum, and minimum response time values were calculated among 1000 sequential real-time predictions. In FIG. 5C, for each input image resolution, it can be observed that the quantized Res-CNN models significantly reduced the prediction response times. The quantized Res-CNN with 40×30 input image resolution achieved an average of 8.317 ms response time, whereas the non-quantized Res-CNN model responded at 91.90 ms. Such a difference in response times was, in fact, a direct consequence of the quantization strategy, which reduced the complexity of the model by converting the floating-point model parameters to integers, hence reducing the complexity of the mathematical operations.

It may still be convenient to use the quantized Res-CNN model with 60×45 input images since 14.45 ms can also be a high-speed response that can be used for pupil detection. With higher resolutions such as 120×90, although it may result in a better prediction performance during the training, it may not be as convenient to use in real-time pupil detection applications since the average prediction response time is 40.94.

FIG. 6D shows the accuracy comparison of quantized and non-quantized models on the LPW test dataset. Both models performed similar RMSE and MAE trends throughout the training. Conventional post-quantization strategies typically reduced float-point model parameters' precision to integers, decreasing prediction performance. The reason for the similar trends between non-quantized and quantized models was the QAT strategy, in which parameters were quantized during the training.

FIG. 6E shows the quantized model results in an accurate and robust performance like the non-quantized Res-CNN model, even though the quantized model significantly outperformed the non-quantized model in terms of the prediction speed. Specifically, FIG. 6E shows the RMSE and MAE comparison of non-quantized and quantized Res-CNN models.

Indeed, experiments showed that the quantized Res-CNN model trained with the QAT strategy performed well on the test dataset while providing real-time predictions on a resource-constrained single-board computer.

### DISCUSSION

DFCN-based segmentation architectures for the pupil center detection problem have achieved accurate and robust performance in recent years. However, despite their precise prediction capabilities, they suffer from high computational power requirements when producing real-time predictions, as they require an extensive number of trainable model parameters to obtain high-accuracy predictions. In this study, we tackle this problem by utilizing an end-to-end quantized pupil detection model with fewer trainable parameters than DFCNs that are trained with QAT strategy to provide not only robust and accurate but also fast predictions for low computational power applications.

Our quantized model consists of several advanced operations, such as residual connections, SE, and ASPP, to improve the prediction performance without significantly increasing the model parameters. We also leverage transfer learning by initially training our model with a dataset that only consists of synthetic eye images and fine-tuning the same model with the actual eye dataset. Furthermore, we integrate the QAT strategy to increase the speed of the predictions. Our experiments showed that our quantized Res-CNN model trained with QAT strategy using 40×30 resolution images performs well on the LPW test dataset while providing real-time predictions on Raspberry Pi with an average of 8.317 ms response time per image. It is also possible to consider 60×45 input images when real-time prediction performance is of interest. However, our findings show that for higher resolutions such as 120×90, prediction response times may not be as convenient since the average response time is achieved at 40.94 ms. Nonetheless, quantized Res-CNN models with QAT outperform conventional Res-CNN models with almost the same prediction accuracy.

Building on the response time and accuracy benefits of the Res-CNN model with QAT strategy, future work should experiment with other eye datasets to obtain a global model with solid generalization ability, such as in monitoring and controlling the operation of an actuator, as discussed above. Moreover, architectural design should also be improved, aiming for a more robust model with fewer parameters, resulting in a faster prediction response. This platform can then be implemented on various applications that demand the use of portable and miniaturized computers to track eye motion at high speed and accuracy.

### Additional Examples

In addition to the eye-tracking examples described above, additional positioning examples are contemplated by this disclosure. For example, object detection and tracking.

As another example, other motion control applications are likewise contemplated. For example, artificial limb control where the artificial limb is controlled to be driven to a target location based on a predicted target location. In one specific example, a walking aid (e.g., artificial leg, supplemental leg, or cane) is controlled to be driven to a target location based on a predicted target location to facilitate walking.

In another example, a hearing aid may leverage the Res-CNN architecture described herein to facilitate real-time audio amplification and/or translation.

Other implementations where low computational power and robust prediction performance may be useful are likewise contemplated by this disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including matters of logic with respect to the arrangement of steps or operational flow, plain meaning derived from grammatical organization or punctuation, and the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

It is understood that throughout this specification, the identifiers “first,” “second,” “third,” “fourth,” “fifth,” “sixth,” and such are used solely to aid in distinguishing the various components and steps of the disclosed subject matter. The identifiers “first,” “second,” “third,” “fourth,” “fifth,” “sixth,” and such are not intended to imply any particular order, sequence, amount, preference, or importance to the components or steps modified by these terms.

All references cited and discussed in this specification are incorporated herein by reference in their entirety and to the same extent as if each reference was individually incorporated by reference.

### REFERENCE

[1] F. Hutmacher, “Why is there so much more research on vision than on any other sensory modality?,” Frontiers in psychology, p. 2246, 2019.
[2] F. J. Vera-Olmos, E. Pardo, H. Melero, and N. Malpica, “DeepEye: Deep convolutional network for pupil detection in real environments,” Integrated Computer-Aided Engineering, vol. 26, no. 1, pp. 85-95, 2019.
[3] I. A. Saad, L. E. George, and A. A. Tayyar, “Accurate and fast pupil localization using contrast stretching, seed filling and circular geometrical constraints,” 2014.
[4] C. W. Jones, W. Sun, H. Boulter, and S. Brown, “3D roughness standard for performance verification of topography instruments for additively-manufactured surface inspection,” Measurement Science and Technology, 2022.
[5] J. P. Tao et al., “A Digital Microscreen for the Enhanced Appearance of Ocular Prosthetic Motility (an American Ophthalmological Society Thesis),” American Journal of Ophthalmology, vol. 228, pp. 35-46, 2021.
[6] Y. LeCun et al., “Handwritten digit recognition with a back-propagation network,” Advances in neural information processing systems, vol. 2, 1989.
[7] W. Rawat and Z. Wang, “Deep convolutional neural networks for image classification: A comprehensive review,” Neural computation, vol. 29, no. 9, pp. 2352-2449, 2017.
[8] W. Fuhl, T. Santini, G. Kasneci, W. Rosenstiel, and E. Kasneci, “Pupilnet v2. 0: Convolutional neural networks for cpu based real time robust pupil detection,” arXiv preprint arXiv:1711.00112, 2017.
[9] W. Chinsatit and T. Saitoh, “CNN-based pupil center detection for wearable gaze estimation system,” Applied Computational Intelligence and Soft Computing, vol. 2017, 2017.
[10] K. He, X. Zhang, S. Ren, and J. Sun, “Deep residual learning for image recognition,” in Proceedings of the IEEE conference on computer vision and pattern recognition, 2016, pp. 770-778.
[11] L.-C. Chen, G. Papandreou, I. Kokkinos, K. Murphy, and A. L. Yuille, “Deeplab: Semantic image segmentation with deep convolutional nets, atrous convolution, and fully connected crfs,” IEEE transactions on pattern analysis and machine intelligence, vol. 40, no. 4, pp. 834-848, 2017.
[12] Y. W. Lee, K. W. Kim, T. M. Hoang, M. Arsalan, and K. R. Park, “Deep residual CNN-based ocular recognition based on rough pupil detection in the images by NIR camera sensor,” Sensors, vol. 19, no. 4, p. 842, 2019.
[13] Y.-H. Yiu et al., “DeepVOG: Open-source pupil segmentation and gaze estimation in neuroscience using deep learning,” Journal of neuroscience methods, vol. 324, p. 108307, 2019.
[14] O. Ronneberger, P. Fischer, and T. Brox, “U-net: Convolutional networks for biomedical image segmentation,” in International Conference on Medical image computing and computer-assisted intervention, 2015: Springer, pp. 234-241.
[15] R. S. Kothari, A. K. Chaudhary, R. J. Bailey, J. B. Pelz, and G. J. Diaz, “Ellseg: An ellipse segmentation framework for robust gaze tracking,” IEEE Transactions on Visualization and Computer Graphics, vol. 27, no. 5, pp. 2757-2767, 2021.
[16] L. Shi, C. Wang, F. Tian, and H. Jia, “An integrated neural network model for pupil detection and tracking,” Soft Computing, vol. 25, no. 15, pp. 10117-10127, 2021.
[17] C. Akinlar, H. K. Kucukkartal, and C. Topal, “Accurate CNN-based pupil segmentation with an ellipse fit error regularization term,” Expert Systems with Applications, vol. 188, p. 116004, 2022.
[18] W. Fuhl, T. Kübler, K. Sippel, W. Rosenstiel, and E. Kasneci, “Excuse: Robust pupil detection in real-world scenarios,” in International conference on computer analysis of images and patterns, 2015: Springer, pp. 39-51.
[19] W. Fuhl, T. C. Santini, T. Kübler, and E. Kasneci, “Else: Ellipse selection for robust pupil detection in real-world environments,” in Proceedings of the Ninth Biennial ACM Symposium on Eye Tracking Research & Applications, 2016, pp. 123-130.
[20] M. Tonsen, X. Zhang, Y. Sugano, and A. Bulling, “Labelled pupils in the wild: a dataset for studying pupil detection in unconstrained environments,” in Proceedings of the ninth biennial ACM symposium on eye tracking research & applications, 2016, pp. 139-142.
[21] V. Badrinarayanan, A. Kendall, and R. Cipolla, “Segnet: A deep convolutional encoder-decoder architecture for image segmentation,” IEEE transactions on pattern analysis and machine intelligence, vol. 39, no. 12, pp. 2481-2495, 2017.
[22] A. Fan et al., “Training with quantization noise for extreme model compression,” arXiv preprint arXiv:2004.07320, 2020.
[23] V. Vanhoucke, A. Senior, and M. Z. Mao, “Improving the speed of neural networks on CPUs,” 2011.
[24] P. Stock, A. Joulin, R. Gribonval, B. Graham, and H. Jegou, “And the bit goes down: Revisiting the quantization of neural networks,” arXiv preprint arXiv:1907.05686, 2019.
[25] B. Jacob et al., “Quantization and training of neural networks for efficient integer-arithmetic-only inference,” in Proceedings of the IEEE conference on computer vision and pattern recognition, 2018, pp. 2704-2713.
[26] Y. Bengio, N. Leonard, and A. Courville, “Estimating or propagating gradients through stochastic neurons for conditional computation,” arXiv preprint arXiv:1308.3432, 2013.
[27] M. Courbariaux and Y. Bengio, “Binarynet: Training deep neural networks with weights and activations constrained to +1 or −1. arXiv 2016,” arXiv preprint arXiv:1602.02830.
[28] J. Hu, L. Shen, and G. Sun, “Squeeze-and-excitation networks,” in Proceedings of the IEEE conference on computer vision and pattern recognition, 2018, pp. 7132-7141.
[29] K. He, X. Zhang, S. Ren, and J. Sun, “Spatial pyramid pooling in deep convolutional networks for visual recognition,” IEEE transactions on pattern analysis and machine intelligence, vol. 37, no. 9, pp. 1904-1916, 2015.
[30] E. Wood, T. Baltrusaitis, X. Zhang, Y. Sugano, P. Robinson, and A. Bulling, “Rendering of eyes for eye-shape registration and gaze estimation,” in Proceedings of the IEEE International Conference on Computer Vision, 2015, pp. 3756-3764.
[31] S. Ioffe and C. Szegedy, “Batch normalization: Accelerating deep network training by reducing internal covariate shift,” in International conference on machine learning, 2015: PMLR, pp. 448-456.
[32] V. Nair and G. E. Hinton, “Rectified linear units improve restricted boltzmann machines,” in Icml, 2010.
[33] M.-H. Guo et al., “Attention mechanisms in computer vision: A survey,” Computational Visual Media, pp. 1-38, 2022.
[34] S. Lazebnik, C. Schmid, and J. Ponce, “Beyond bags of features: Spatial pyramid matching for recognizing natural scene categories,” in 2006 IEEE computer society conference on computer vision and pattern recognition (CVPR'06), 2006, vol. 2: IEEE, pp. 2169-2178.
[35] Y. Wang, B. Liang, M. Ding, and J. Li, “Dense semantic labeling with atrous spatial pyramid pooling and decoder for high-resolution remote sensing imagery,” Remote Sensing, vol. 11, no. 1, p. 20, 2018.
[36] J. Wang, P. Lv, H. Wang, and C. Shi, “SAR-U-Net: Squeeze-and-excitation block and atrous spatial pyramid pooling based residual U-Net for automatic liver segmentation in Computed Tomography,” Computer Methods and Programs in Biomedicine, vol. 208, p. 106268, 2021.
[37] Y. Sun, L. Wang, Y. Chen, and M. Liu, “Accurate lane detection with atrous convolution and spatial pyramid pooling for autonomous driving,” in 2019 IEEE International Conference on Robotics and Biomimetics (ROBIO), 2019: IEEE, pp. 642-647.
[38] L.-C. Chen, Y. Zhu, G. Papandreou, F. Schroff, and H. Adam, “Encoder-decoder with atrous separable convolution for semantic image segmentation,” in Proceedings of the European conference on computer vision (ECCV), 2018, pp. 801-818.
[39] D. P. Kingma and J. Ba, “Adam: A method for stochastic optimization,” arXiv preprint arXiv:1412.6980, 2014.
[40] K. He, X. Zhang, S. Ren, and J. Sun, “Delving deep into rectifiers: Surpassing human-level performance on imagenet classification,” in Proceedings of the IEEE international conference on computer vision, 2015, pp. 1026-1034.
[41] Weisson, Ernesto H., et al., “Automated noncontact facial topography mapping, 3-dimensional printing, and silicone casting of orbital prosthesis,” American journal of ophthalmology 220 (2020): 27-36.

1. A system, comprising:
equipment with one or more actuators; and
an embedded controller in communication with one or more sensors, the embedded controller configured to process inputs from the one or more sensors and responsively actuate the one or more actuators, wherein the embedded controller comprises a Residual Convolutional Neural Network (Res-CNN), the Res-CNN comprising:
a series of a plurality of residual blocks, each of the residual blocks comprising:
a first connection sequence including a convolutional layer, a fully connected layer, and a batch normalization layer between the convolutional layer and the fully connected layer; and
a skip connection, including a second convolutional layer and a second batch normalization layer,
wherein outputs of the first connection sequence and the skip connection are summed;
a squeeze and excitation network between each of the plurality of residual blocks;
an Atrous Spatial Pyramid Pooling (ASPP) block at an output of the series of the plurality of residual blocks;
a global average pooling (GAP) block at an output of the ASPP block;
a linear block at an output of the GAP block; and
an output block at an output of the linear block.

2. The system of claim 1, wherein each of the first connection sequence of each of the residual blocks further comprises:
a third convolutional layer after the batch normalization layer; and
a third batch normalization layer after the third convolutional layer.

3. The system of claim 1, wherein each of the residual blocks further comprises:
a second fully connected layer at an output of the sum.

4. The system of claim 1, wherein the squeeze and excitation network comprises:
a second GAP block configured to collect global spatial information of an input feature map to the squeeze and excitation network;
a third fully connected network and a fourth fully connected network configured in a second sequence with the second GAP block to produce output attention vectors,
wherein the attention vectors are multiplied by the input feature map.

5. The system of claim 1, wherein the ASPP block comprises:
a plurality of convolution blocks, each with a different dilation rate, wherein each of the plurality of convolution blocks comprise a third sequence with a fourth convolutional layer, a fifth fully connected layer, and a fourth batch normalization layer between the fourth convolutional layer and the fifth fully connected layer;
a concatenation layer configured to concatenate feature maps from the plurality of convolution blocks along a channel dimension; and
a convolutional block configured to produce a final feature map as the output for the ASPP block.

6. The system of claim 1, wherein the linear block comprises a fourth sequence with a linear layer, a sixth fully connected layer, and a fifth batch normalization layer.

7. The system of claim 1, wherein the series of a plurality of residual blocks includes three residual blocks.

8. The system of claim 1, wherein the output block includes a linear layer with a number of neurons equal to a number of output classes to the Res-CNN and an activation layer.

9. (canceled)

10. The system of claim 1, wherein the one or more sensors include one or more of a camera, an image sensor, an optical sensor, a temperature sensor, a pressure sensor, a proximity sensor, a position sensor, a displacement sensor, a force sensor, an accelerometer, a voltage sensor, a current sensor, a gas sensor, a smoke sensor, a decibel meter, or a microphone.

11. The system of claim 1, wherein the one or more actuators include one or more of a linear actuator, a rotary actuator, a valve actuator, a slide gate actuator, a hydraulic actuator, an electric actuator, a pneumatic actuator, a magnetic actuator, trigger, button.

12. A non-transitory computer readable medium comprising one or more memory structures of a Residual Convolutional Neural Network (Res-CNN), comprising:
a series of a plurality of residual blocks, each of the residual blocks comprising:
a first connection sequence including a convolutional layer, a fully connected layer, and a batch normalization layer between the convolutional layer and the fully connected layer; and
a skip connection including a second convolutional layer and a second batch normalization layer,
wherein outputs of the first connection sequence and the skip connection are summed;
a squeeze and excitation network between each of the plurality of residual blocks;
an Atrous Spatial Pyramid Pooling (ASPP) block at an output of the series of the plurality of residual blocks;
a global average pooling (GAP) block at an output of the ASPP block;
a linear block at an output of the GAP block; and
an output block at an output of the linear block.

13. The non-transitory computer-readable medium of claim 12, wherein each of the plurality of residual blocks in the series has an increased number of neurons than an immediately preceding residual block in the series.

14. The non-transitory computer-readable medium of claim 12, wherein each of the first connection sequence of each of the residual blocks further comprises:
a third convolutional layer after the batch normalization layer; and
a third batch normalization layer after the third convolutional layer.

15. The non-transitory computer-readable medium of claim 12, wherein each of the residual blocks further comprises:
a second fully connected layer at an output of the sum.

16. The non-transitory computer-readable medium of claim 12, wherein the squeeze and excitation network comprises:
a second GAP block configured to collect global spatial information of an input feature map to the squeeze and excitation network;
a third fully connected network and a fourth fully connected network configured in a second sequence with the second GAP block to produce output attention vectors,
wherein the attention vectors are multiplied by the input feature map.

17. The non-transitory computer-readable medium of claim 12, wherein the ASPP block comprises:
a plurality of convolution blocks, each with a different dilation rate, wherein each of the plurality of convolution blocks comprises a third sequence with a fourth convolutional layer, a fifth fully connected layer, and a fourth batch normalization layer between the fourth convolutional layer and the fifth fully connected layer;
a concatenation layer configured to concatenate feature maps from the plurality of convolution blocks along a channel dimension; and
a convolutional block configured to produce a final feature map as the output for the ASPP block.

18. The non-transitory computer-readable medium of claim 12, wherein the linear block comprises a fourth sequence with a linear layer, a sixth fully connected layer, and a fifth batch normalization layer.

19. The non-transitory computer-readable medium of claim 12, wherein the series of a plurality of residual blocks includes three residual blocks.

20. The non-transitory computer-readable medium of claim 12, wherein the convolutional layer in the first connection sequence has a 7×7 kernel size, and the second convolutional layer in the skip connection has a 3×3 kernel size.

21. The non-transitory computer-readable medium of claim 12, wherein the output block includes a linear layer with a number of neurons equal to a number of output classes to the Res-CNN and an activation layer.

22. (canceled)
